(19) United States
(12) Patent Application Publication
(10) Pub. No.: US 2006/0042742 A1
(43) Pub. Date: Mar. 2, 2006

(54) Method and apparatus for inspecting a material

(76) Inventors: Marc L. Keller, Salem, IL (US); Maurens A. Gomes, Salem, IL (US); Richard L. Powless, Salem, IL (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 10/931,055

(22) Filed: Aug. 31, 2004

(51) Int. Cl. B32B 37/00; G01N 21/86

(52) U.S. Cl. 156/64; 250/559.4

(57) ABSTRACT

A detection system for detecting solvent on a web of material, wherein the solvent includes light sensitive material, includes a detection assembly including an enclosure having side walls defining a cavity, wherein the enclosure is configured to prevent ambient light from entering the cavity, at least one illumination source for generating light towards the light sensitive material, and a camera positioned within the cavity and configured to produce a signal relating to an image of the web. The system also includes a monitoring assembly located outside of the cavity and configured to receive the signal from the camera. The monitoring assembly includes a display for displaying the image of the web for determining the quality of the solvent application on the web based on the presence or the absence of the light sensitive material.

### BACKGROUND OF THE INVENTION

This invention relates generally to inspection and detection methods and apparatus, and more particularly, to methods and apparatus for inspecting and detecting a solvent application to a web of material.

Inspection systems and devices are generally known for inspecting webs of material for quality control issues such as defects. Some known inspection systems are used to inspect the presence and uniformity of a viscous fluid, such as an adhesive, a lubricant, a sealant, or the like, on the material web. In some known applications, a light sensitive material is added to the viscous fluid prior to inspection of the web by an operator. Generally, the web is channeled into a darkened environment and illuminated using a light, such as a black light. The web is then viewed by an operator. In some known systems, the web is viewed through a portal by the operator. However, such systems require constant supervision by an operator and allow ambient light into the viewing environment.

In other known systems, an observation room is provided through which the web of material is passed. The room is darkened so that the operator can visually inspect the web to assess the quality of the fluid application. However, such systems generally occupy a large amount of floor space, thus increasing the overall cost of manufacture. Additionally, such systems require constant monitoring by an operator thereby monopolizing all of the operators time. As such, a need exists for an improved detection device used in quality inspections of web material.

### BRIEF DESCRIPTION OF THE INVENTION

In one aspect, a solvent applicator system for a web of material is provided, wherein the web of material passes through the solvent applicator system. The solvent applicator system includes a solvent applicator configured to apply a solvent including a light sensitive material, to a length of the web as it passes through the solvent applicator system. The system also includes a detection device configured to detect the light sensitive material in the solvent, and configured to generate an image of the web, and a monitoring device configured to display the image of the web generated by the detection device for determining at least one of the presence and absence of the solvent on the web based on the light sensitivity of the light sensitive material.

In another aspect, a detection system is provided for detecting solvent on a web of material, wherein the solvent includes light sensitive material. The system includes a detection assembly including an enclosure defining a cavity, wherein the enclosure is configured to prevent ambient light from entering the cavity, at least one illumination source for generating light towards the light sensitive material, and a camera positioned within the cavity and configured to generate a signal relating to an image of the web. The system also includes a monitoring assembly including a display located outside of the cavity, wherein the monitoring assembly is configured to receive the signal from the camera, and configured to display the image of the web generated from the signal.

In yet another aspect, a shrink sleeve forming apparatus is provided for forming a shrink sleeve from a web of material, wherein the web includes a line of adhesive along the length of the web, and the adhesive includes light sensitive material therein. The shrink sleeve forming apparatus includes a rolling assembly configured to channel the web through the forming apparatus and configured to roll the shrink sleeves into a roll of material, and a detection assembly positioned adjacent the web. The detection assembly includes an enclosure and a monitor. The enclosure includes a camera and at least one illumination source, wherein the enclosure is configured to prevent ambient light from entering the viewing area of the camera, the illumination source is configured to illuminate the web, and the camera is configured to generate an image of the web for display on the monitor. The apparatus also includes a forming assembly for forming the shrink sleeve from the web, wherein the shrink sleeve is formed by coupling the ends of the web using the adhesive.

In a further aspect, a monitoring assembly is provided for viewing an image of a web of material, wherein the web of material includes a solvent having a light sensitive material therein. The monitoring assembly includes a monitor configured to display an image from a camera positioned within an enclosure that excludes ambient light therefrom. An illumination source is positioned within the enclosure for generating light towards the light sensitive material, and the image displayed on the monitor relates to at least one of the presence and the absence of the solvent on the web. The monitor is located outside of the enclosure such that the image displayed on the monitor is viewable in the ambient light. The assembly also includes a photo detector positioned adjacent the monitor for sensing the intensity of the light emitted from the monitor, wherein the intensity of the light is proportional to the amount of light sensitive material on the web.

In yet a further aspect, a method is provided for detecting the presence of light sensitive material on a web of material using a detecting assembly and a monitoring assembly. The detecting assembly includes an enclosure configured to prevent ambient light from entering the enclosure, at least one illumination source for generating light towards the light sensitive material, and a camera configured to produce a signal relating to an image of the web, and the monitoring assembly includes a display. The method includes passing the web of material along an open side of the enclosure, illuminating the light sensitive material on the web using the illumination source, generating an image of the web using the camera, and viewing the image of the web using the display.

In another aspect, a method is provided for generating a shrink sleeve from a web of material. The method includes applying adhesive to the web of material, wherein the adhesive includes light sensitive material, and inspecting the adhesive using a detection assembly positioned adjacent the web. The detection assembly includes an enclosure and a monitor, wherein the enclosure includes a camera and at least one illumination source. The enclosure is configured to prevent ambient light from entering the viewing area of the camera, the illumination source is configured to illuminate the light sensitive material in the adhesive, and the camera is configured to generate an image of the web for display on the monitor. The method also includes generating the shrink sleeve from the web by coupling the ends of the web using the adhesive.

### BRIEF DESCRIPTION OF THE DRAWINGS

FIG. 1 is a top view of a web of material used to fabricate a shrink sleeve in accordance with the present invention.

FIG. 2 is an end view of the shrink sleeve in a formed state and fabricated from the web of material shown in FIG. 1.

FIG. 3 is a schematic illustration of an exemplary detection system for inspecting the web of material as shown in FIG. 1.

FIG. 4 is a side view of a detection device for use with the detection system shown in FIG. 3.

FIG. 5 is a rear view of the detection device shown in FIG. 4.

### DETAILED DESCRIPTION OF THE INVENTION

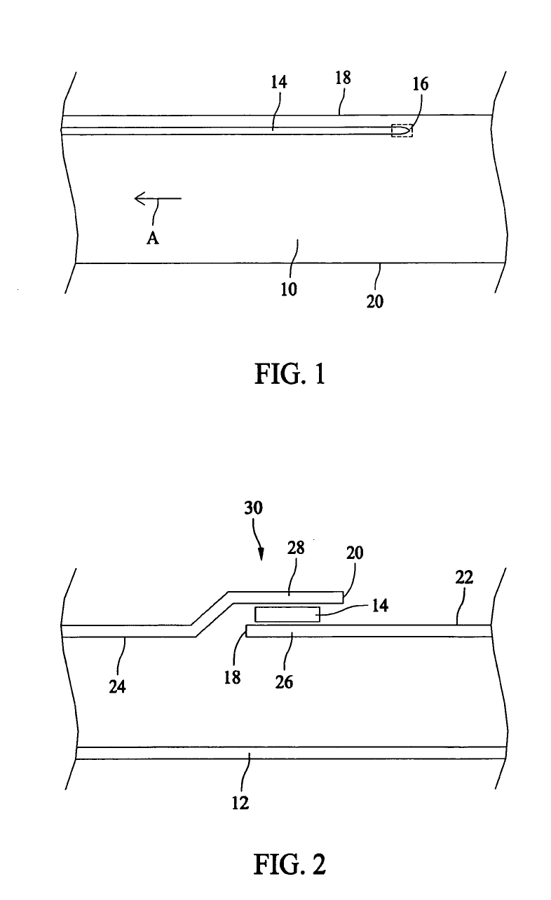

FIG. 1 illustrates a top view of a web 10 of material. In the exemplary embodiment, web 10 is fabricated from a plastic material, such as, but not limited to, oriented polystyrene (OPS). In an alternative embodiment, the plastic material may be, for example, a polyvinyl chloride (PVC) material, a polyester (PET) material, a glycol-modified polyester (GPET) material, or the like. In the exemplary embodiment, web 10 travels in the direction of arrow A as a strip of solvent 14 is applied to a surface of web 10. In the exemplary embodiment, solvent 14, also referred to hereinafter as adhesive, is applied generally in an area of application 16. Area of application 16 is positioned between a first end 18 and a second end 20 of web 10. In one embodiment, area of application 16 is positioned proximate first end 18.

FIG. 2 illustrates an end view of a shrink sleeve 12 in a formed state and fabricated from web 10 (shown in FIG. 1). Specifically, adhesive 14 is applied to a portion of shrink sleeve 12 prior to forming a tubular sleeve. In the exemplary embodiment, adhesive 14 is applied to a first surface 22 of shrink sleeve 12 proximate first end 18. Second end 20 is wrapped around first end 18 and a second surface 24 of shrink sleeve 12 is coupled to adhesive 14 to form the tubular sleeve. As such, adhesive 14 is positioned between an under flap 26, extending from first end 18, and an over flap 28, extending from second end 20. Over flap 28, solvent 14, and under flap 26 define a seam 30 in shrink sleeve 12.

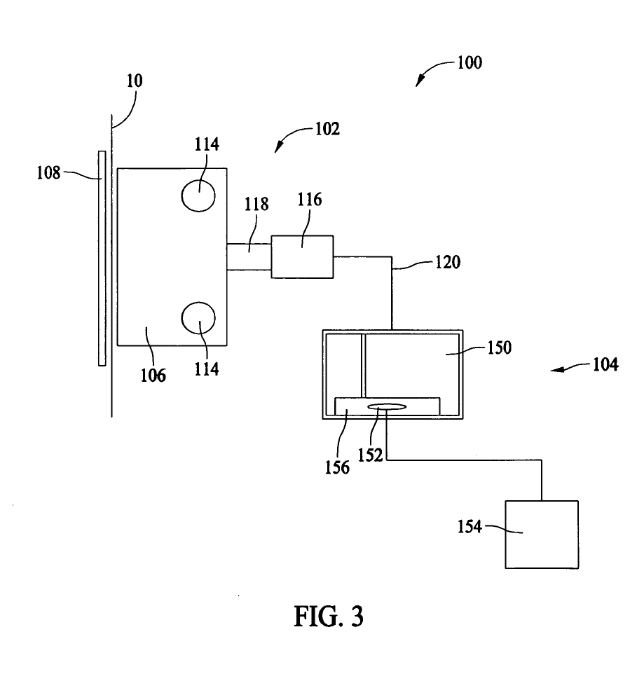

FIG. 3 is a schematic illustration of a detection system 100, including a detection device 102 for inspecting web 10 as shown in FIG. 1. Detection system 100 is configured to perform a seam analysis wherein detection system 100 is configured to detect the presence, absence, and/or quality of the strip of solvent 14 on the web 10. It is to be understood that the invention can be utilized in and for a variety of applications, including, but not limited to, the inspection of shrink sleeves, such as shrink sleeve 12. It is appreciated that the benefits and advantages of the invention may occur in a variety of detection systems that may be utilized in detecting or inspecting a variety of products fabricated from a web-like material. While the invention is described and illustrated in the context of a detection system 100 for detecting the presence, absence, and/or quality of solvent 14 on shrink sleeves 12, the invention is not limited thereto.

As illustrated in FIG. 3, detection system 100 includes a detection device 102, and a monitoring device 104. In the exemplary embodiment, detection device 102 includes an enclosure 106 for isolating web 10 from ambient light. Web 10 travels along detection device 102 so that detection device 102 can inspect the solvent line forming seam 30 in shrink sleeve 12. Specifically, due to the light sensitive material contained within solvent 14, detection device 102 is capable of detecting the presence, absence, and/or quality of solvent 14 application to web 10. In the exemplary embodiment, detection device 102 also includes a back plate 108 positioned proximate web 10 such that detection device 102 surrounds web 10 as it travels along detection device 102. Back plate 108 is positioned opposite web 10 to eliminate ambient light from filtering through the back side of web 10. In one embodiment, back plate 108 is positioned a distance 110 from enclosure 106 such that a gap 112 is formed between back plate 108 and enclosure 106. Web 10 is passed through gap 112 between back plate 108 and enclosure 106. In an alternative embodiment, back plate 108 is coupled to enclosure 106 and web 10 passes through an opening in enclosure 106. In the exemplary embodiment, enclosure 106 and/or back plate 108 have a dark coloring, such as, for example, black, to provide a background against which the light sensitive material on web 10 can be compared. As such, enclosure 106 and back plate 108 form a “black box” for isolating web 10 from ambient light.

Detection device 102 also includes at least one illumination source 114 for illuminating web 10 as it passes by detection device 102. In the exemplary embodiment, illumination source 114 is, but is not limited to, an ultra violet (“UV”) illumination source 114 for illuminating web 10 using UV light. As such, any light sensitive material present on web 10 is illuminated by the UV light so that the material glows. Accordingly, the presence, absence, and/or quality of solvent 14 on shrink sleeve 12 is detectable by detection device 102. In one embodiment, illumination source 114 provides a strobe effect such that illumination source 114 is switched between an ON and an OFF mode of operation.

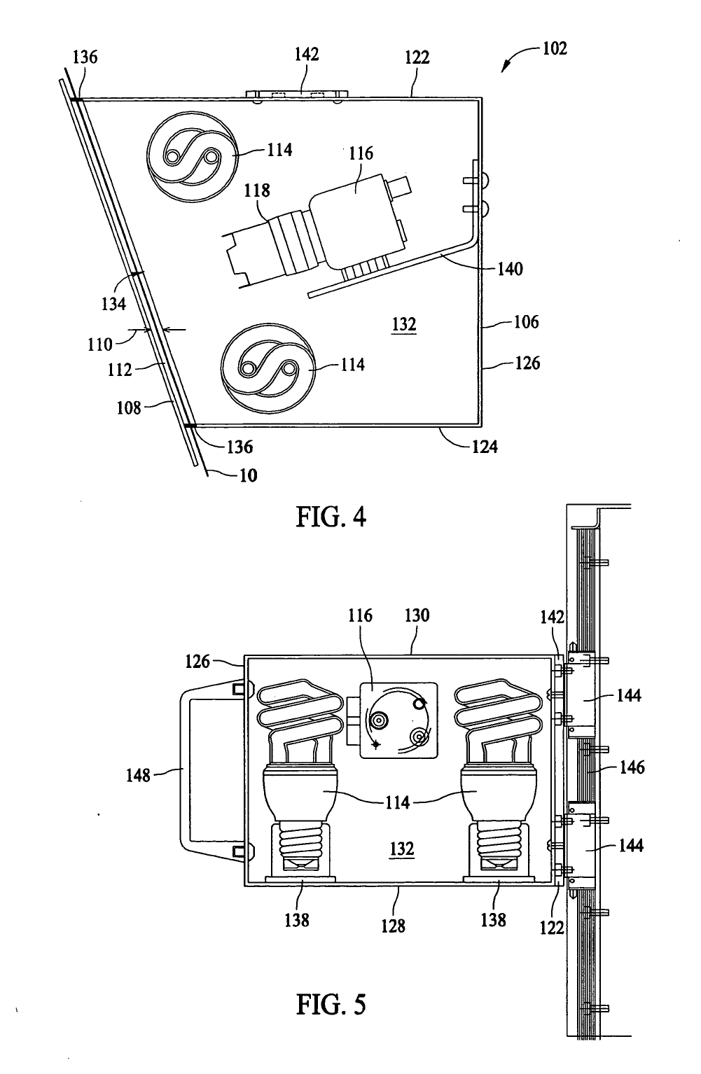

Detection device 102 includes a camera 116 having a lens 118 for inspecting web 10 as it travels along enclosure 106. Specifically, camera 116 is coupled to enclosure 106 and oriented to view web 10. In the illustrative embodiment of FIGS. 4 and 5, camera 116 is positioned within enclosure 106. However, in an alternative embodiment, camera 116 is positioned outside of enclosure 106, and lens 118 is positioned adjacent an opening (not shown) in enclosure 106 such that web 10 is viewable by camera 116. In the exemplary embodiment, camera 116 is a high resolution color camera for producing high resolution images of web 10, however, camera 116 is not limited thereto. In one embodiment, camera 116 includes at least one filter (not shown) for filtering predetermined colors such that the image produced by camera 116 is limited to solvent 14 in seam 30. In an alternative embodiment, camera 116 is an ultraviolet sensitive camera having a filter for blocking frequencies above and below the ultraviolet frequency such that only solvent 14 having the ultraviolet light sensitive material is viewable by camera 116. Additionally, lens 118 is a variable focus lens to allow for precision focus of solvent 14 on web 10, although, lens 118 is not limited thereto. The images produced by camera 116 are transmitted by a cable 120 to monitoring device 104. In another embodiment, the images may be transmitted by other means, such as, but not limited to satellite signals, and other wireless means.

Monitoring device 104 includes a display 122, such as but not limited to, a video monitor, for viewing the images produced by camera 116 and for monitoring the consistency of solvent 14 application to web 10. In the exemplary embodiment, display 122 is an LCD color monitor for displaying the high resolution images produced by camera 116, however, display 122 is not limited thereto. Display 122 is viewable by inspecting personnel to manually and clearly view the presence and quality of solvent 14 on web 10 due to the illumination of the light sensitive material by illumination source 114. Due to the positioning of display 122 in a remote location with respect to detection device 102, the inspection personnel are not physically located within enclosure 106, thereby eliminating the need for a large detection device 102. Additionally, the inspecting personnel do not have to view web 10 through an inspection portal, thereby reducing fatigue of the personnel and eliminating the need for an opening in enclosure 106 through which ambient light may enter.

Monitoring device 104 also includes a photo detector 124 and a signal level detector 126. In the exemplary embodiment, photo detector 124 is a photosensitive device, such as, but not limited to a photodiode. Photo detector 124 includes a light capture hood 128 positioned adjacent display 122 for preventing ambient light from entering and/or interfering with photo detector 124. In use, photo detector 124 senses the intensity of the light emitted from display 122, specifically, the light emitted from the image of the line of solvent 14. As a result of the absorption of photons emitted from display 122, photo detector 124 produces a photo-voltage that supports the conduction of a photo-current. As such, photo detector 124 converts the photons from the light on display 122 to an electrical signal. Photo detector 124 sends the signal, which is proportional to the intensity of light sensed by photo detector 124, to signal level detector 126. In an alternative embodiment, detection system 100 is operated without camera 116 and/or display 122 by coupling photo detector 124 within enclosure 106 and directly detecting the illumination of web 10.

Signal level detector 126 receives the signal transmitted by photo detector 124. In one embodiment, signal level detector 126 includes an electrical circuit that receives the electrical signal transmitted by photo detector 124, and when the signal transmitted through the circuit is below a predetermined amount, the status of such is indicated by signal level detector 126. In another embodiment, when the signal received by signal level detector 126 is below a predetermined limit or amount, signal level detector 126 signals an alarm condition to a controller (not shown). In one embodiment, when the controller receives an alarm condition signal from signal level detector 126, the controller halts operations relating to the manufacture of web 10. As such, monitoring device 104 causes a system reaction, such as a halt in operation, even if the inspecting personnel are not monitoring display 122.

FIG. 4 is a side view of detection device 102, and FIG. 5 is a rear view of detection device 102. In the exemplary embodiment, enclosure 106 includes top and bottom walls 130 and 132, respectively, a back wall 134, and first and second side walls 136 and 138, respectively, defining a cavity 140. Additionally, walls 130, 132, 136 and 138 define a front opening 142 through which web 10 is viewable. In the exemplary embodiment, top wall 130 is longer than bottom wall 132 such that front opening 142 is angled therebetween. Top wall 130 is longer to facilitate covering enclosure 106 and reducing the amount of ambient light that enters enclosure 106. Additionally, back plate 108 extends along front opening 142 to prevent ambient light from entering enclosure 106 through the back side of web 10. Back plate 108 is positioned at distance 110 to define gap 112, and web travels within gap 112. In the exemplary embodiment, a spacer 144 is positioned within gap 112 to prevent ambient light from entering enclosure 106 through gap 112. Spacer 144 also prevents web 10 from contacting enclosure 106. In one embodiment, spacer 144 is fabricated from a brush-like material. In another embodiment, spacer 144 is fabricated from a felt material. In an alternative embodiment, enclosure 106 includes a front wall (not shown) and a pair of openings (not shown) in top and bottom walls 130 and 132, respectively, such that web 10 extends through the openings.

In the exemplary embodiment, enclosure 106 includes two illumination sources 114 positioned within cavity 140 near front opening 142. Specifically, one illumination source 114 is positioned adjacent top wall 130 and the other illumination source 114 is positioned adjacent bottom wall 132. In alternative embodiments, illumination sources 114 are in alternate positions. Illumination sources 114 are coupled to corresponding screw bases 146 extending from a wall, such as, side wall 136. Additionally, in the exemplary embodiment, camera 116 is mounted to a camera mount 148 coupled to back wall 134 and extending outward into cavity 140. Camera 116 is positioned between illumination sources 114 and lens 118 extends parallel to web 10.

In the exemplary embodiment, enclosure 106 is moveable so that enclosure 106 is positionable relative to the position of web 10. Specifically, enclosure 106 includes a mounting plate 150 extending along top wall 130, and a plurality of mounting brackets 152 coupled to mounting plate 150. Mounting brackets 152 are slidably coupled to a rail 154. In an alternative embodiment, enclosure 106 is coupled to a movable arm (not shown) such that enclosure 106 is moveable in a three dimensional coordinate system. Additionally, in alternative embodiments, mounting plate 150 is mounted to bottom wall 132 or side walls 136 or 138. In the exemplary embodiment, enclosure 106 includes a handle 156 for moving enclosure 106.

The above-described detection system for inspecting a web of material operates in a cost-effective and reliable manner. The detection system includes a detection device and a monitoring device. The detection device facilitates preventing ambient light from entering a viewing area of the web. Additionally, the detection device illuminates the web with an illumination source that causes light sensitive material in the solvent on the web to react. The detection device also includes a camera for generating an image of the web and the reaction of the light sensitive material. The camera transmits the image to the monitoring device to be viewed on a display away from the detection device. Additionally, the monitoring system includes a photo detector for sensing the intensity of the light emitted from the display which is proportional to the amount of light sensitive material on the web. As a result the detection system facilitates detecting the presence of the light sensitive material in a reliable and cost-effective manner by increasing the ease with which the solvent may be detected. Additionally, the presence of the solvent may be automatically detected with the use of the photo detector.

Exemplary embodiments of detection systems are described above in detail. The systems are not limited to the specific embodiments described herein, but rather, components of each system may be utilized independently and separately from other components described herein. For example, each detection system component can also be used in combination with other detection system components.

While the invention has been described in terms of various specific embodiments, those skilled in the art will recognize that the invention can be practiced with modification within the spirit and scope of the claims.

What is claimed is:

1. A solvent applicator system for a web of material, wherein the web of material passes through said solvent applicator system, said solvent applicator system comprising:
a solvent applicator configured to apply solvent including a light sensitive material to a length of the web as the web passes through said solvent applicator system;
a detection device positioned adjacent the web, said detection device configured to detect the light sensitive material in the solvent, and configured to generate an image of the web; and
a monitoring device configured to display the image of the web generated by said detection device for determining at least one of the presence and absence of said solvent on the web based on the light sensitivity of the light sensitive material.

2. A system in accordance with claim 1 wherein the image being viewed on said monitoring device is viewed in the ambient light.

3. A system in accordance with claim 1 wherein the light sensitive material comprises an ultraviolet light sensitive material.

4. A system in accordance with claim 1 wherein said solvent is applied by said solvent applicator in a line along the length of the web.

5. A system in accordance with claim 1 wherein the solvent comprises an adhesive and the web is used to fabricate a roll of shrink sleeve material.

6. A system in accordance with claim 1 wherein said detection device comprises:
an enclosure configured to prevent ambient light from entering therein;
at least one illumination source for generating light towards the light sensitive material; and
a camera positioned within said enclosure and oriented to view the web to generate the image of the web.

7. A system in accordance with claim 6 further comprising a back plate extending along an open side of said enclosure such that a gap is defined between said back plate and said enclosure, the web configured to be oriented within said gap.

8. A system in accordance with claim 7 further comprising a spacer extending between said side walls of said enclosure and said back plate, said spacer for preventing ambient light from entering enclosure.

9. A system in accordance with claim 6 wherein the light sensitive material comprises an ultraviolet light sensitive material, said illumination source is configured to generate ultraviolet light.

10. A system in accordance with claim 1 wherein said monitoring assembly further comprises a photo detector for sensing the intensity of the light emitted from the image displayed on said monitoring device, wherein the intensity of the light is proportional to the amount of light sensitive material on the web.

11. A system in accordance with claim 10 wherein said monitoring assembly further comprises a signal level detector operatively coupled to said photo detector for signaling an alarm condition when the intensity of the light detected by photo detector is below a predetermined limit.

12. A detection system for detecting solvent on a web of material, wherein the solvent includes light sensitive material, said detection system comprising:
a detection assembly comprising an enclosure defining a cavity, said enclosure positioned adjacent the web and configured to prevent ambient light from entering the cavity, at least one illumination source positioned within the cavity and configured to generate light towards the light sensitive material, and a camera positioned within the cavity and configured to generate a signal based on the image of the web; and
a monitoring assembly operatively coupled to said camera, said monitoring assembly comprising a display located outside of the cavity, said monitoring assembly configured to receive the signal from said camera and configured to display the image of the web generated from the signal.

13. A system in accordance with claim 12 further comprising a back plate extending along a portion of the cavity such that a gap is defined between said back plate and the cavity, the article is configured to be oriented with said gap.

14. A system in accordance with claim 13 further comprising a spacer extending between said enclosure and said back plate, said spacer for preventing ambient light from entering enclosure.

15. A system in accordance with claim 12 wherein said detection assembly is positionable along a width of the web such that the light sensitive material is viewable by said camera.

16. A system in accordance with claim 12 wherein the light sensitive material includes ultraviolet light sensitive material, and said illumination source is configured to generate ultraviolet light.

17. A system in accordance with claim 12 wherein said monitoring assembly further comprises a photo detector for sensing the intensity of the light emitted from said display, wherein the intensity of the light is proportional to the amount of light sensitive material on the web.

18. A system in accordance with claim 17 wherein said monitoring assembly further comprises a signal level detector operatively coupled to said photo detector for signaling an alarm condition when the intensity of the light detected by said photo detector is below a predetermined limit.

19. A shrink sleeve forming apparatus for forming a shrink sleeve from a web of material, the web includes a line of adhesive along the length of the web, the adhesive includes light sensitive material therein, said shrink sleeve forming apparatus comprises:
a rolling assembly configured to channel the web through said forming apparatus and configured to roll the shrink sleeves into a roll of material;
a detection assembly positioned adjacent the web, said detection assembly comprising an enclosure and a monitor, said enclosure comprising a camera and at least one illumination source, said enclosure configured to prevent ambient light from entering the viewing area of said camera, said illumination source configured to illuminate the web, said camera configured to generate an image of the web for display on said monitor; and
a forming assembly for forming the shrink sleeve from the web, wherein the shrink sleeve is formed by coupling the ends of the web using the adhesive.

20. An apparatus in accordance with claim 19 wherein said monitor is positioned remote from said enclosure.

21. An apparatus in accordance with claim 19 wherein the image being viewed on said monitor is viewed in the ambient light.

22. An apparatus in accordance with claim 19 wherein the light sensitive material comprises an ultraviolet light sensitive material.

23. An apparatus in accordance with claim 19 wherein said detection assembly further comprises a photo detector for sensing the intensity of the light emitted from the image displayed on said monitor, wherein the intensity of the light is proportional to the amount of light sensitive material on the web.

24. An apparatus in accordance with claim 23 wherein said detection assembly further comprises a signal level detector operatively coupled to said photo detector for signaling an alarm condition when the intensity of the light detected by photo detector is below a predetermined limit.

25. A monitoring assembly for viewing an image of a web of material, wherein the web of material includes a solvent having a light sensitive material therein, said monitoring assembly comprising:
a monitor configured to display an image from a camera positioned within an enclosure that excludes ambient light therefrom, wherein an illumination source is positioned within the enclosure for generating light towards the light sensitive material, the image displayed on said monitor relating to at least one of the presence and the absence of the solvent on the web, said monitor located outside of the enclosure such that the image displayed on said monitor is viewable in the ambient light; and
a photo detector positioned adjacent said monitor for sensing the intensity of the light emitted from said monitor, wherein the intensity of the light is proportional to the amount of light sensitive material on the web.

26. A monitoring assembly in accordance with claim 25 wherein the image view on said monitor is based on the light sensitivity of the light sensitive material in the solvent.

27. A monitoring assembly in accordance with claim 25 wherein the light sensitive material includes ultraviolet light sensitive material, and the illumination source is configured to generate ultraviolet light, such that the intensity of the image displayed on said monitor is based on the amount of solvent on the web.

28. A monitoring assembly in accordance with claim 25 wherein said photo detector comprises a hood surrounding said photo detector and configured to prevent ambient light from entering said photo detector.

29. A monitoring assembly in accordance with claim 25 further comprises a signal level detector operatively coupled to said photo detector for signaling an alarm condition when the intensity of the light detected by said photo detector is below a predetermined limit.

30. A method for detecting the presence of light sensitive material on a web of material using a detecting assembly and a monitoring assembly, wherein the detecting assembly includes an enclosure configured to prevent ambient light from entering the enclosure, at least one illumination source for generating light towards the light sensitive material, and a camera configured to produce a signal relating to an image of the web, and the monitoring assembly includes a display, said method comprising:
passing the web of material along an open side of the enclosure;
illuminating the light sensitive material on the web using the illumination source;
generating an image of the web using the camera; and
viewing the image of the web using the display.

31. A method in accordance with claim 30 wherein the detecting assembly further includes a back plate extending along the open side of the enclosure such that a gap is formed between the back plate and the enclosure, said passing the web of material comprises passing the web of material along the gap between the enclosure and the back plate.

32. A method in accordance with claim 30 wherein the light sensitive material includes ultraviolet light sensitive material, said illuminating the light sensitive material comprises illuminating the light sensitive material using ultraviolet light.

33. A method in accordance with claim 30 wherein said generating an image of the web comprises generating a high resolution color image of the web.

34. A method in accordance with claim 30 further comprising filtering the wavelength frequencies above and below the frequency of the light sensitive material.

35. A method in accordance with claim 30 wherein the monitoring assembly further includes a photo detector, said viewing the image of the web comprises viewing the image of the web using the photo detector to sense the intensity of the light emitted from the display, wherein the intensity of the light is proportional to the amount of light sensitive material on the web.

36. A method in accordance with claim 35 wherein the monitoring assembly further includes a signal level detector operatively coupled to the photo detector, said method further comprising signaling an alarm condition when the intensity of the light detected by photo detector is below a predetermined limit.

37. A method for generating a shrink sleeve from a web of material, said method comprises:
applying adhesive to the web of material, wherein the adhesive includes light sensitive material;
inspecting the adhesive using a detection assembly positioned adjacent the web, wherein the detection assembly includes an enclosure and a monitor, the enclosure includes a camera and at least one illumination source, the enclosure is configured to prevent ambient light from entering the viewing area of the camera, the illumination source is configured to illuminate the light sensitive material in the adhesive, and the camera is configured to generate an image of the web for display on the monitor; and
generating the shrink sleeve from the web by coupling the ends of the web using the adhesive.

38. A method in accordance with claim 37 wherein the detection assembly further includes a photo detector positioned adjacent the monitor, said inspecting the adhesive comprises viewing the image of the web using the photo detector to sense the intensity of the light emitted from the monitor, wherein the intensity of the light is proportional to the amount of light sensitive material in the adhesive.

39. A method in accordance with claim 38 wherein the detection assembly further includes a signal level detector operatively coupled to the photo detector, said method further comprising signaling an alarm condition when the intensity of the light detected by photo detector is below a predetermined limit.
